(19) United States
(12) Patent Application Publication
(10) Pub. No.: US 2024/0095587 A1
(43) Pub. Date: Mar. 21, 2024

(54) METHODS AND APPARATUSES FOR PROVIDING TRANSFER LEARNING OF A MACHINE LEARNING MODEL

(71) Applicant: TELEFONAKTIEBOLAGET LM ERICSSON (PUBL), Stockholm (SE)

(72) Inventors: Andreas JOHNSSON, Uppsala (SE); Farnaz MORADI, Bromma (SE); Jalil TAGHIA, Stockholm (SE); Hannes LARSSON, Soina (SE)

(73) Assignee: TELEFONAKTIEBOLAGET LM ERICSSON (PUBL), Stockholm (SE)

(21) Appl. No.: 18/266,021

(22) PCT Filed: Dec. 8, 2020
(86) PCT No.: PCT/SE2020/051178

§ 371 Date: Jun. 8, 2023

(51) Int. Cl. G06N 20/00

(52) U.S. Cl. CPC G06N 20/00

(57) ABSTRACT

A computer-implemented method is provided for determining whether a machine learning model in a candidate source domain is suitable for use in a target domain, wherein the machine learning model is trained with one or more features. The method comprises for each feature: determining one or more target measurement configurations indicating how data for the feature can be generated in the target domain; for each feature, performing, for each of a plurality of candidate source domains, the steps of: determining one or more source measurement configurations indicating how data for the feature can be generated in the candidate source domain, determining a similarity metric indicative of a similarity between the one or more source measurement configurations and the one or more target measurement configurations; and based on the similarity metrics determined for each feature for the plurality of candidate source domains, selecting one or more selected source domains from the plurality of candidate source domains.

### TECHNICAL FIELD

Embodiments described herein relate to method and apparatuses for providing transfer learning of a machine learning model in a source domain to a target domain.

In particular, methods and embodiments described herein utilize domain knowledge to determine which of a plurality of candidate source domains may be used to provide the transfer learning.

### BACKGROUND

Internet of Things (IoT) is an emerging technology that comes with great opportunities in areas such as health care, industry, and smart homes. One definition of IoT is the inter-networking of physical devices, vehicles, buildings, factories, and other items. These items can be equipped with sensors but also actuators. Often, these items are also connected to a traditional network.

Management of IoT systems and associated data collection is challenging due to complexity, heterogeneity, and scale in terms of connected devices. Promising management approaches are being developed based on machine learning (ML). However, a key challenge in ML model creation for IoT systems is the difficulty to maintain the accuracy of a model over time, as well as how to reuse knowledge learned from one IoT environment in another IoT environment.

IoT devices are often constrained in terms of limited resources for data collection and ML model training. Moreover, IoT devices are quite heterogeneous and can therefore differ in their compute, storage, and communication capabilities, running different operating system and software. Further, different IoT devices can collect data using different methods using different tools with different configurations. Reusing ML models in this environment may therefore be challenging since the exact definition and measurement tools for features can differ.

An ML model is dependent on input features obtained using a set of measurement tools. To improve the performance of the ML model, for example, in a newly deployed target system, transfer learning may be utilized whereby the new ML model in a target domain can learn from a ML model previously trained in a source domain.

In recent years, such transfer learning has received considerable attention, specifically in areas such as image, video, and sound recognition. In traditional ML, each task is learnt from scratch using training data obtained from a domain and making predictions for data from the same domain. However, sometimes there is not sufficient amount of data for training available in the domain of interest. In these cases, transfer learning can be used to transfer knowledge from a domain where sufficient training data is available to the domain of interest in order to improve the accuracy of the ML task.

Transfer learning may be defined as follows: given a source domain Dₛ and learning task Tₛ, a target domain D_{T} and learning task T_{T}, transfer learning aims to help improve the learning of the target predictive function fT(·) in D_{T} using the knowledge in Dₛ and Tₛ, where Dₛ #D_{T}, or Tₛ≠T_{T}.

Transfer learning methods can be divided into two main categories; homogeneous and heterogeneous. In homogeneous transfer learning the feature space in the source and target domains are the same, while in heterogeneous transfer learning the source and target domains can have different feature spaces.

An example from image analysis is to develop a ML model for recognizing a specific object in a set of images. The source domain corresponds to the set of images and the learning task is to recognize the object itself. Modeling a second learning task, recognizing a second object in the original set of images, corresponds to a transfer learning case where the source domain and target domains are the same, while the learning task differs.

In a telecom/cloud environment a source domain may refer to an ML model trained with features from a specific type of IoT device, whereas the target domain corresponds to an upgraded version of the same IoT device with slightly different configuration and sensor capabilities.

In “Identifying transfer models for machine learning tasks” (US 20190354850 A1) a method for selecting the best source domain for a given target domain is disclosed. The selection is based on a similarity metric calculated using source- and target domain data sets. The similarity metric is based on statistical properties of the two data sets.

In “Method and Apparatus for Determining a Based Model for Transfer Learning” (US20200134469A1) a method for measuring the suitability of pretrained models in the source domain and its use in a target domain is disclosed. This method is also based on statistical properties of the features and models.

Existing techniques (such as the ones described above) for transfer learning are mainly considering statistical properties of: the ML models, the features, and the data distributions.

However, for resource-constrained systems, such as IoT devices, it may be challenging to rely on statistical similarity between a source and target domain, for example, due to resource shortages and high energy consumption for such similarity calculations. This issue is not currently addressed by any state-of-the-art method for source-domain selection in transfer learning.

### SUMMARY

According to some embodiments there is provided a computer-implemented method for determining whether a machine learning model in a candidate source domain is suitable for use in a target domain, wherein the machine learning model is trained with one or more features. The method comprises for each feature: determining one or more target measurement configurations indicating how data for the feature can be generated in the target domain; for each feature, performing, for each of a plurality of candidate source domains, the steps of: determining one or more source measurement configurations indicating how data for the feature can be generated in the candidate source domain, determining a similarity metric indicative of a similarity between the one or more source measurement configurations and the one or more target measurement configurations; and based on the similarity metrics determined for each feature for the plurality of candidate source domains, selecting one or more selected source domains from the plurality of candidate source domains.

In some embodiments the method further comprises transmitting an indication of the one or more selected source domains to the target domain. This indication may then be used by the target domain to initiate transfer learning from one or more of the one or more selected source domains to the target domain.

In some embodiments the method further comprises, for each feature: obtaining an ontology for the feature, wherein the ontology describes possible measurement configurations that can be used to generate data for the feature in the plurality of candidate source domains and the target domain. An ontology may be a simple way to collect the data relating to the one or more source measurement configurations and the one or more target measurement configurations.

The one or more source measurement configurations and the one or more target measurement configurations may form paths through the ontology. In some embodiments, for each feature, the step of determining the similarity metric comprises comparing the paths through the ontology taken by the one or more source measurement configurations and the one or more target measurement configurations.

In some embodiments, for each feature, the similarity metric comprises a sum of hops in the paths through the ontology taken by the one or more source measurement configurations and the one or more target measurement configurations that overlap. Comparing the paths through the ontology in this way requires minimal processing.

In some embodiments, the sum is a weighted sum wherein each hop is associated with a weighting. By weighting each hop in the path the method allows for emphasis to be placed on certain elements within the measurement configurations.

In some embodiments the method further comprises calculating an overall similarity based on the similarity metrics for each of the one or more features. In some embodiments the method comprises calculating the overall similarity by summing the similarity metrics for each of the one or more features. Calculating an overall similarity based on the similarity metrics for each of the one or more features allows for the consideration of all the features for each source domain when determining which source domains may be suitable for transfer learning.

In some embodiments, the overall similarity is a weighted sum of the similarity metrics for the each of the one or more features. Weighting each of the one or more features allows for the method to take into account whether or not some features may be more important to a particular model than other features. For example the output of a model may have a higher dependency on a first feature than a second feature. The weighting of the first feature may therefore be higher.

In some embodiments the method further comprises, determining that the candidate source domain is suitable for use in the target domain based on a value of the overall similarity being above a predetermined threshold. The use of the predetermined threshold may avoid any source domains being suggested to the target domain when the overall similarity is low.

In some embodiments the method comprises ranking the candidate source domains based on the value of the overall similarities, wherein candidate source domains with a higher overall similarities are ranked higher. In some embodiments the method further comprises selecting the one or more selected source domains as the highest ranked candidate source domains.

In some embodiments, the target measurement configurations and source measurement configurations comprise one or more of: a measurement protocol, a sensor type, a measurement frequency, a measurement application, a sampling interval, and a network layer.

In some embodiments, the target domain comprises one or more Internet of Things, IoT, devices. The use of the embodiments described above in an IoT system may avoid the need for the statistical analysis of data that is not necessarily readily available in such environments. In some embodiments, the method is performed by an edge network node.

According to some embodiments there is provided a method, in a target domain, for receiving a model trained with one or more features. The method comprising obtaining a one or more selected source domains; selecting a first source domain from the one or more selected source domains; transmitting a request to a model store for a model definition associated with the first source domain; receiving the model definition; and utilizing the model based on the model definition in the target domain.

In some embodiments the method further comprises updating weights in the model based on data collected in the target domain. By updating weights in the model based on data collected in the target domain, the target domain may improve the model, and may make the model more effective within the target domain.

In some embodiments the method further comprises updating an ontology store with changes to one or more target measurement configurations indicating how data for the one or more features can be generated in the target domain.

According to some embodiments there is provided an apparatus for determining whether a machine learning model in a candidate source domain is suitable for use in a target domain, wherein the machine learning model is trained with one or more features. The apparatus comprises processing circuitry configured to cause the apparatus to: for each feature: determine one or more target measurement configurations indicating how data for the feature can be generated in the target domain; for each feature, perform, for each of a plurality of candidate source domains, the steps of: determining one or more source measurement configurations indicating how data for the feature can be generated in the candidate source domain, determining a similarity metric indicative of a similarity between the one or more source measurement configurations and the one or more target measurement configurations; and based on the similarity metrics determined for each feature for the plurality of candidate source domains, select one or more selected source domains from the plurality of candidate source domains.

According to some embodiments there is provided a target domain, for receiving a model trained with one or more features. The target domain comprises processing circuitry configured to: obtain a one or more selected source domains; select a first source domain from the one or more selected source domains; transmit a request to a model store for a model definition associated with the first source domain; receive the model definition; and utilize the model based on the model definition in the target domain.

The various embodiments described above address the problem of how to provide transfer learning without the use of statistical properties of: the ML models, the features, and the data distributions. By utilizing the similarity metrics as described above, the embodiments described herein provide a way to determine which source domains would be suitable for transfer learning without requiring statistical analysis of data collected in the source or target domains. The embodiments described above may therefore be more suitable for applications in environments using constrained devices such as IoT devices than previous solutions for performing selection of a source domain for transfer learning.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates a computer-implemented method for determining whether a machine learning model in a candidate source domain is suitable for use in a target domain;

FIG. 2a illustrates an example ontology for the feature “temperature”;

FIG. 2b illustrates an example ontology for the feature “throughput”;

FIG. 3 illustrates an example of a target measurement configuration forming a path through the “throughput” ontology of FIG. 2b;

FIG. 4a illustrates an example of a first source measurement configuration in a first candidate source domain;

FIG. 4b illustrates an example of a second source measurement configuration in a second candidate source domain;

FIG. 5 illustrates an example implementation of step 104 of FIG. 1;

FIG. 6 is a signaling diagram illustrating how the method of FIG. 1 may be initiated;

FIG. 7 illustrates an apparatus comprising processing circuitry (or logic);

FIG. 8 illustrates a target domain comprising processing circuitry (or logic).

### DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Embodiments described herein provide methods and apparatuses for determining whether a source-domain model Mₛ, trained using data from a set of measurement tools/sensors in the source domain, can be transferred to a target domain, given the current set of measurement tools/sensors available in the target domain. That is, methods and apparatuses described herein may determine if the measurement capabilities (for examples, the specific tools, sensor types, measurement frequencies, etc.) that produce the features of the source domain, Xₛ and the features of the target domain, XT, are similar enough for transfer learning of the model from the source domain to the target domain.

Existing techniques for transfer learning are mainly considering statistical properties of the ML models, the features, and the data distributions. That is, in existing solutions well-established domain knowledge (with respect to feature definitions and measurement tools) is not incorporated when selecting the best source domain for a target domain, nor do existing solutions exploit the fact that the target domain measurement system can be configured to mimic the source domain.

For resource-constrained systems, such as IoT devices, it may be challenging to rely on statistical similarity between a source and target domain, for example, due to resource shortages and high energy consumption for such similarity calculations. This issue is not currently addressed by any state-of-the-art method for source-domain selection in transfer learning.

For the purposes of the present disclosure, a constrained device comprises a device which conforms to the definition set out in section 2.1 of IETF RFC 7228 for “constrained node”. According to the definition in IETF RFC 7228, a constrained device is a device in which “some of the characteristics that are otherwise pretty much taken for granted for Internet nodes at the time of writing are not attainable, often due to cost constraints and/or physical constraints on characteristics such as size, weight, and available power and energy. The tight limits on power, memory, and processing resources lead to hard upper bounds on state, code space, and processing cycles, making optimization of energy and network bandwidth usage a dominating consideration in all design requirements. Also, some layer-2 services such as full connectivity and broadcast/multicast may be lacking”. Constrained devices are thus clearly distinguished from server systems, desktop, laptop or tablet computers and powerful mobile devices such as smartphones. A constrained device may for example comprise a Machine Type Communication device, a battery powered device or any other device having the above discussed limitations. Examples of constrained devices may include sensors measuring temperature, humidity and gas content, for example within a room or while goods are transported and stored, motion sensors for controlling light bulbs, sensors measuring light that can be used to control shutters, heart rate monitors and other sensors for personal health (continuous monitoring of blood pressure etc.) actuators and connected electronic door locks. IoT devices may comprise examples of constrained devices.

It will be appreciated that the embodiments described herein may be utilised for any suitable environment, not just for systems utilising constrained devices. For example, the embodiments described herein may be applied in systems in which the measurement capabilities of devices may change.

Embodiments described herein therefore provide a method for determining transfer learning domain similarity, using feature ontologies created from domain knowledge. In some examples, a set of top-ranked source domains is proposed for a given target domain. If the similarity between features is high enough, a machine learning, ML model can be transferred from the source domain to the target domain, where it may be refined using new target-domain samples.

The target domain measurement system may also be re-configured to resemble the source domain measurement system in order to improve the benefits of transfer learning.

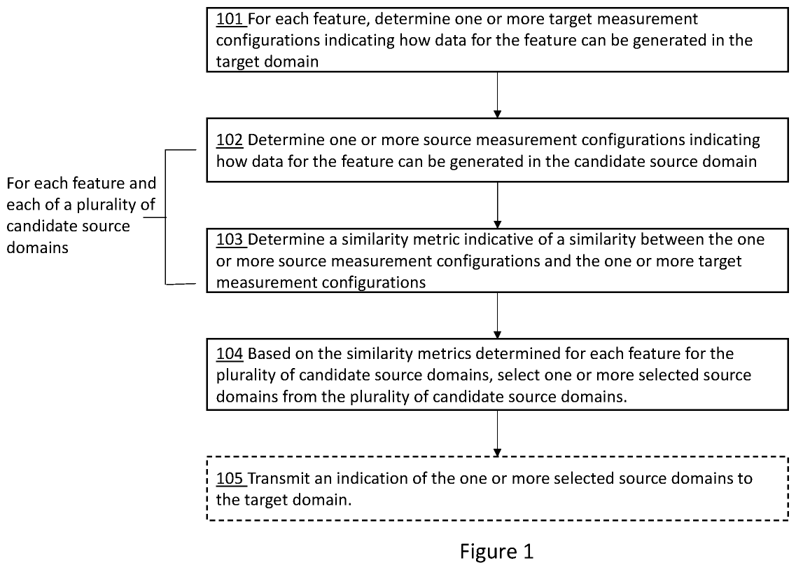

FIG. 1 illustrates a computer-implemented method for determining whether a ML model in a candidate source domain is suitable for use in a target domain. The machine learning model in the candidate source domain is trained with one or more features. In some examples, for a particular target domain there may be a plurality of available candidate source domains each with a ML model, M_{s,i} that may be transferred to the target domain. Each ML model M_{s,i} may be trained with a set of features [f₁, . . . , fₙ]. The set of features used to train each ML model may be different.

The method illustrated in FIG. 1 may be performed by the target domain, or in an apparatus outside of the target domain and the plurality of candidate source domains. The method may for example be performed by a virtual node or may be a virtual node, which may comprise any logical entity, for example running in a cloud, edge cloud or fog deployment.

In some examples, the ML model may be configured to predict and forecast power consumption of an IoT device, or set of devices in a domain. In some examples, the ML is configured to use ML for prediction of radio sleeping time, based, for example, on how often, when, and/or how much data is transported.

In some examples, the ML model may determine, based on temperature when to an alarm (for example a fire alarm) should be raised.

In some examples, the target domain may comprise an IoT device domain collecting data from one or more IoT devices, and each candidate source domain may comprise an IoT device domain collecting data from one or more IoT devices. In these examples, the method of FIG. 1 may be performed by the target domain or, for example a network edge node, e.g. a gateway node.

For each feature used by any of the ML models, M_{i,s} in the plurality of source domains, in step 101, the method comprises determining one or more target measurement configurations indicating how data for the feature can be generated in the target domain. A target measurement configuration may for example comprise one or more of: a measurement protocol, a sensor type, a measurement frequency, a measurement application, a sampling interval and/or a network layer used to generate data for a particular feature. It will be appreciated that there may be a plurality of available target measurement configurations in the target domain for generating data for the same feature.

The method may then perform the steps 102 and 103 for each feature and for each of the plurality of candidate source domains.

In step 102, the method comprises determining one or more source measurement configurations indicating how data for the feature can be generated in the candidate source domain. Similarly to the target measurement configurations, a source measurement configuration may, for example, comprise one or more of: a measurement protocol, a sensor type, a measurement frequency, a measurement application, a sampling interval and/or a network layer used to generate data for a particular feature. It will be appreciated that there may be a plurality of available source measurement configurations in each candidate source domain for generating data for the same feature.

In step 103, the method comprises determining a similarity metric indicative of a similarity between the one or more source measurement configurations and the one or more target measurement configurations. Where a plurality of source measurement configurations and/or a plurality of target measurement configurations are available, similarity metrics may be calculated for each combination of source-target configurations. A similarity metric may then be selected from those calculated, for example, the selected similarity metric comprise the similarity metric for the most similar source measurement configuration and target measurement configuration.

At this point, the method has generated similarity metrics for each feature in each of the plurality of candidate source domains.

In step 104, the method comprises, based on the similarity metrics determined for each feature for the plurality of candidate source domains, selecting one or more selected source domains from the plurality of candidate source domains.

In some examples in which the method is performed outside of the target domain, the method may further comprise step 105 of transmitting an indication of the one or more selected source domains to the target domain. In some examples, the selected source domains may be candidate source domains having the highest similarity metrics.

In other words, by exploiting target domain and candidate source domain knowledge with respect to features and the measurement configurations used to measure the features, the method of FIG. 1 may select selected source domains that may be suitable for transfer to the target domain. As this method is agnostic to the actual data available in the candidate source domains and the target domain, it may be particularly useful in circumstances in which the amount of data available is limited, such as IoT domains.

In some embodiments, each of the one or more target measurement configurations and the one or more source measurement configurations form paths through an ontology. The ontology may therefore map features to protocols and/or actual measurement tools/sensors and configurations. Such an ontology may be pre-defined by a domain expert, and available for both the source and target domains. For example, standards and/or specifications may be utilised to determine an ontology. In some examples, therefore the method may comprise, for each feature, obtaining an ontology for the feature, wherein the ontology describes possible measurement configurations that can be used to generate data for the feature in the plurality of candidate source domains and the target domain.

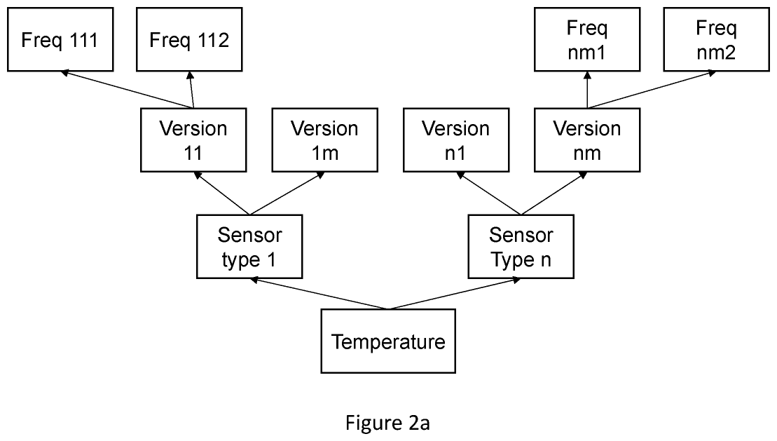

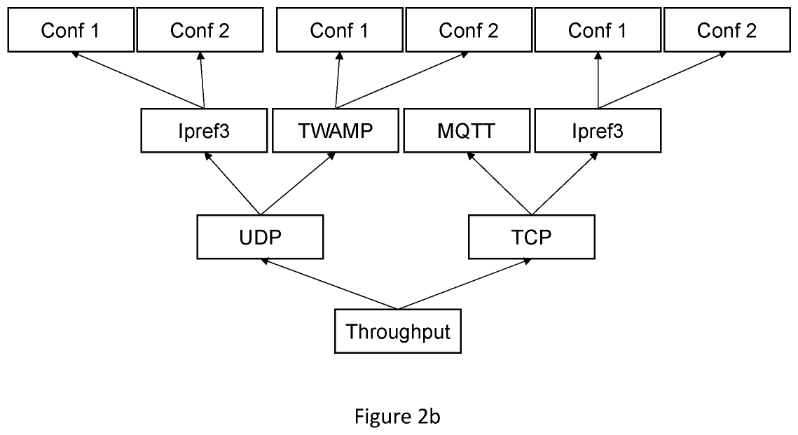

FIG. 2a illustrates an example ontology for the feature “temperature”. In this example, across the candidate source domains and the target domain, the feature “temperature” may be measured using different types of sensors and versions of sensors, with different configurations (e.g. frequency). Note that the ontology is simplified and merely serves as an example.

FIG. 2b illustrates an example ontology for the feature “throughput”. In this example, across the candidate source domains and the target domain there are a number of different possible measurement configurations for the throughput feature. For example, throughput may be measured either over User Datagram Protocol (UDP) or Transmission Control Protocol (TCP), using different tools and strategies, and so on. Lastly, the ontology indicates that the data for the throughput feature may be configured with a measurement frequency.

The example ontologies are depicted using a tree-like structure with a hierarchy of elements to the available measurement configurations. It will be appreciated that other forms of ontology may be used.

Each layer of the ontology is may be associated with a different element, for example, for the ontology in FIG. 2a, the elements may be: type of sensor, version of sensor and frequency configuration. Each box within the layer corresponds to available classes for each element. For example, the element sensor type has the available classes of “Sensor type 1” and “Sensor type 2”.

Consider an example in which ML models in two example candidate source domains are trained based on the features “throughput” and “temperature”. It will be appreciated that in some examples the features used to train ML models in different candidate source domains may be different.

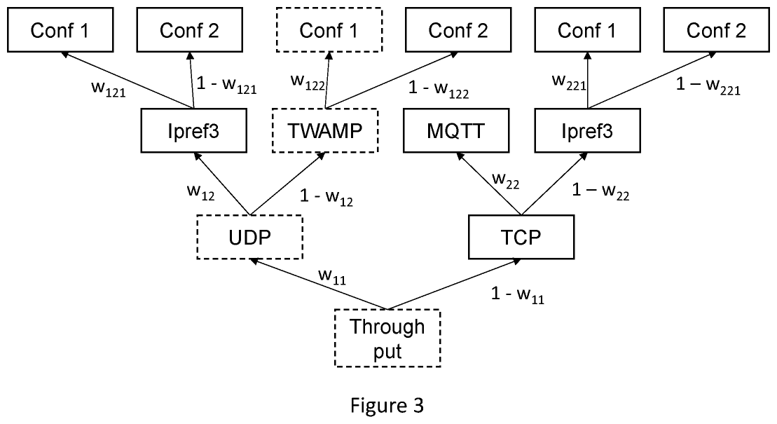

In step 101 of FIG. 1, the method may comprise determining paths through ontology made by the one or more target measurement configurations. FIG. 3 illustrates an example of a target measurement configuration forming a path through the “throughput” ontology of FIG. 2b.

In this example only one target measurement configuration is illustrated. It will however be appreciated that a target domain may be able to provide a plurality of target measurement configurations for a particular feature.

In FIG. 3, the dotted boxes illustrate the path formed by the target measurement configuration. In this example therefore, the target measurement configuration comprises measuring throughput over UDP using a Two-way Active Measurement Protocol (TWAMP) in a particular configuration, Conf 1. Each dotted box describing the target measurement configuration may be considered a “hop” in the path formed by the target measurement configuration.), or may be measured more sporadically.

In step 502, the met hod comprises ranking the plurality candidate source domains based on the value of the overall similarities, wherein candidate source domains with a higher overall similarities are ranked higher. In some examples, the ranking is also based on statistical metrics determined from data available in either the candidate source domain or the target source domain.

In step 503 the method comprises selecting the one or more selected source domains as the highest ranked candidate source domains. The number of domains included in the one or more selected domains may depend on a predetermined policy. In some examples, the candidate source domains may be selected as part of the one or more selected source domains if the value of their associated overall similarity is greater than a predetermined threshold.

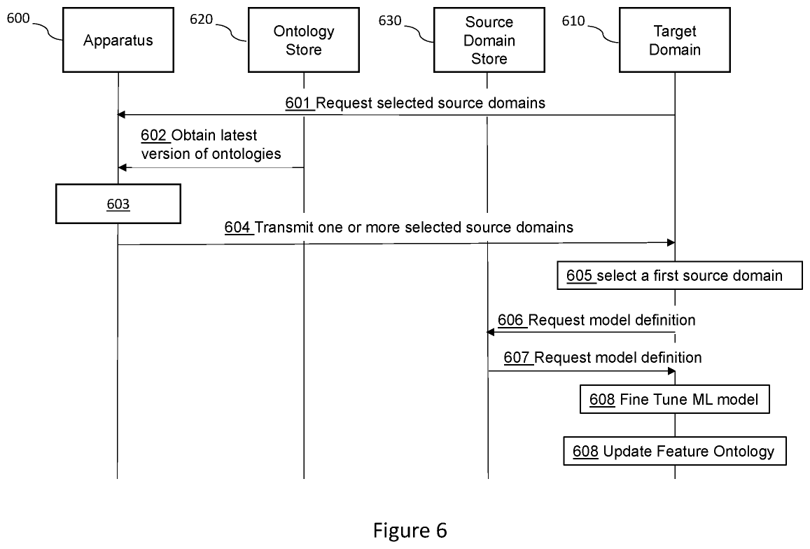

FIG. 6 is a signalling diagram illustrating how the method of FIG. 1 may be initiated.

In this example the method of FIG. 1 is performed by an apparatus 600 outside of the target domain 610. It will however be appreciated that the apparatus 600 may be part of the target domain 610.

In step 601, the target domain 610 transmits a request for one or more top-ranked candidate source domains to the apparatus 600. In other words, the target domain requests that the apparatus transmit one or more selected source domains. In some examples, the request is triggered by initialization of a new target domain, e.g. an IoT device, where parts of the functionality of the domain is ML-driven. For the ML functionality to be booted the target domain can request a source-domain to extract knowledge from.

In step 602a, the apparatus 600 transmits a request for the latest version of one or more ontologies for one or more features used by a plurality of available candidate source domains. The plurality of candidate source domains may be predefined based on the type of target domain, e.g. a cloud domain or a network domain.

In step 602b, the ontology store 620 transmits the latest version of the one or more ontologies to the apparatus 600. In some examples, the ontology store 620 is triggered to send the latest version of the one or more ontologies to the apparatus 600 by another means, for example by the target domain.

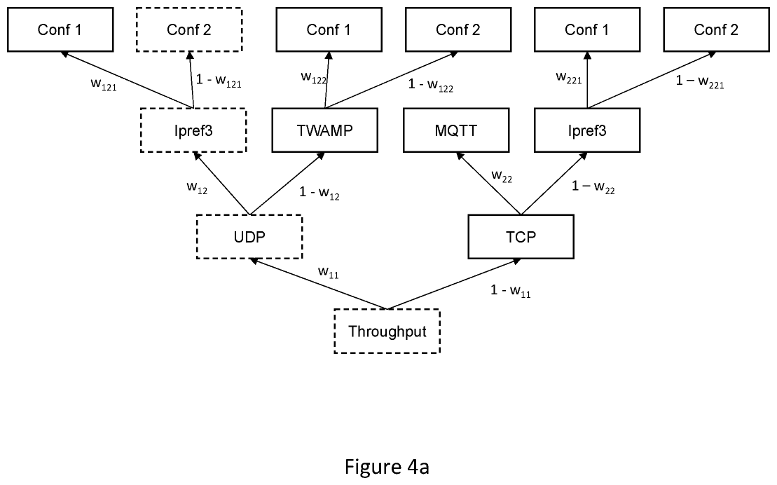

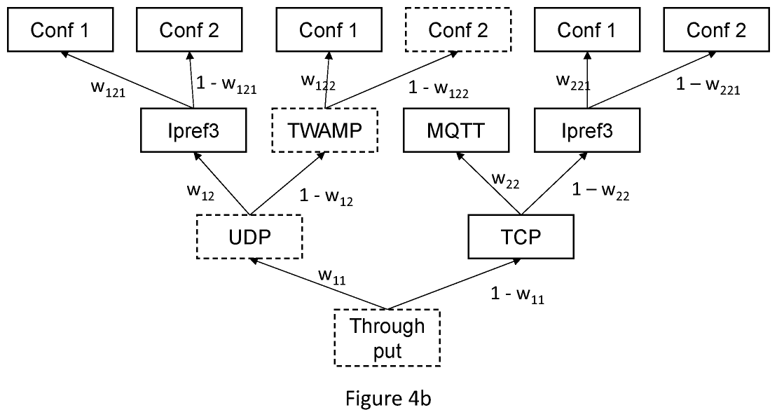

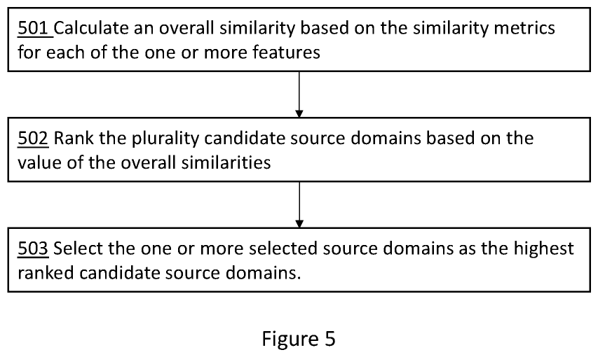

In step 603, the apparatus 600 performs the method as described with reference to FIGS. 1 to 5.

In step 604, the apparatus 600 transmits the one or more selected source domains resulting from step 603 to the target domain 610. It will be appreciated that in embodiments in which the target domain performed the method of FIG. 1, the target domain may have obtained the one or more selected source domains by performing the method of FIG. 1.

In step 605, the target domain 610 selects one of the one or more selected source domains. In some examples, the target domain 610 selects a first source domain from the one or more selected source domains. For example, the first source domain may comprise the highest ranked of the one or more selected source domains. In some examples, each source domain may be associated with a cost. The target source domain may therefore balance the cost associated with each of selected source domains with the associated cost when making the selection of step 605.

In some examples, the target domain may select multiple source domains in step 605. In this example, the models from the multiple source domains may be combined to potentially improve the resulting model even further.

In step 606, the target domain transmits a request to a source domain model store 630 for a definition of a ML model associated with the first source domain. This request may comprise an identification of the first source domain.

In step 607, the source domain model store 630 transmits a definition of the ML model associated with the first source domain to the target domain 610. In some examples, the model store 630 also transmits data collected by the first source domain in performance of the ML model. The definition of the ML model may comprise for example information relating to a structure of a neural network, or parameters associated with a reinforcement learning model. The definition of the ML model may comprise information to allow the target domain to utilize the ML model of the first source domain.

In some examples, in step 608, the target domain fine-tunes the ML model. For example, the target domain may utilize the ML model and may update weights in the ML model based on data collected in the target domain.

In some examples, in step 609, the target domain updates the one or more feature ontologies with new insights regarding feature and edge weights. For example, the target domain 610 may update the ontology store 620 with changes to one or more target measurement configurations indicating how data for the one or more features can be generated in the target domain.

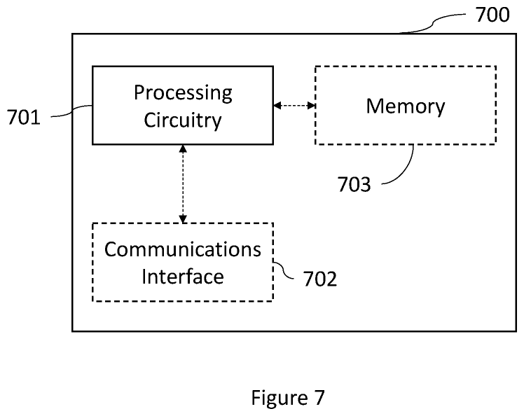

FIG. 7 illustrates an apparatus 700 comprising processing circuitry (or logic) 701. The processing circuitry 701 controls the operation of the apparatus 700 and can implement the method described herein in relation to an apparatus 700. The processing circuitry 701 can comprise one or more processors, processing units, multi-core processors or modules that are configured or programmed to control the apparatus 700 in the manner described herein. In particular implementations, the processing circuitry 701 can comprise a plurality of software and/or hardware modules that are each configured to perform, or are for performing, individual or multiple steps of the method described herein in relation to the apparatus 700.

Briefly, the processing circuitry 701 of the apparatus 700 is configured to: for each feature: determine one or more target measurement configurations indicating how data for the feature can be generated in the target domain; for each feature, perform, for each of a plurality of candidate source domains, the steps of: determining one or more source measurement configurations indicating how data for the feature can be generated in the candidate source domain, and determining a similarity metric indicative of a similarity between the one or more source measurement configurations and the one or more target measurement configurations; and, based on the similarity metrics determined for each feature for the plurality of candidate source domains, select one or more selected source domains from the plurality of candidate source domains.

In some embodiments, the apparatus 700 may optionally comprise a communications interface 702. The communications interface 702 of the apparatus 700 can be for use in communicating with other nodes, such as other virtual nodes. For example, the communications interface 702 of the apparatus 700 can be configured to transmit to and/or receive from other nodes requests, resources, information, data, signals, or similar. The processing circuitry 701 of apparatus 700 may be configured to control the communications interface 702 of the apparatus 700 to transmit to and/or receive from other nodes requests, resources, information, data, signals, or similar.

Optionally, the apparatus 700 may comprise a memory 703. In some embodiments, the memory 703 of the apparatus 700 can be configured to store program code that can be executed by the processing circuitry 701 of the apparatus 700 to perform the method described herein in relation to the apparatus 700. Alternatively or in addition, the memory 703 of the apparatus 700, can be configured to store any requests, resources, information, data, signals, or similar that are described herein. The processing circuitry 701 of the apparatus 700 may be configured to control the memory 703 of the apparatus 700 to store any requests, resources, information, data, signals, or similar that are described herein.

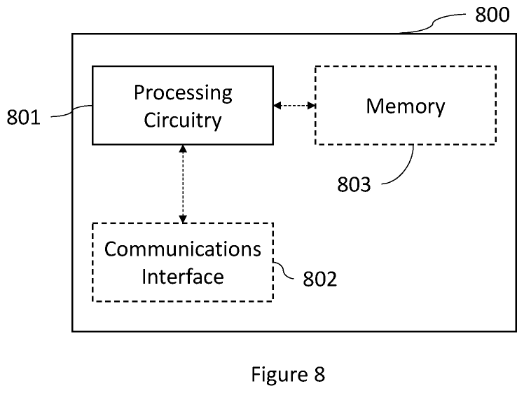

FIG. 8 illustrates a target domain 800 comprising processing circuitry (or logic) 801. The processing circuitry 801 controls the operation of the target domain 800 and can implement the method described herein in relation to a target domain 800. The processing circuitry 801 can comprise one or more processors, processing units, multi-core processors or modules that are configured or programmed to control the target domain 800 in the manner described herein. In particular implementations, the processing circuitry 801 can comprise a plurality of software and/or hardware modules that are each configured to perform, or are for performing, individual or multiple steps of the method described herein in relation to the target domain 800.

Briefly, the processing circuitry 801 of the target domain 800 is configured to: obtain a one or more selected source domains; select a one of the one or more selected source domains; transmit a request to a model store for a model definition associated with one of the one or more selected source domains; receive the model definition; and utilize the model based on the model definition in the target domain.

In some embodiments, the target domain 800 may optionally comprise a communications interface 802. The communications interface 802 of the target domain 800 can be for use in communicating with other nodes, such as other virtual nodes.

For example, the communications interface 802 of the target domain 800 can be configured to transmit to and/or receive from other nodes requests, resources, information, data, signals, or similar. The processing circuitry 801 of target domain 800 may be configured to control the communications interface 802 of the target domain 800 to transmit to and/or receive from other nodes requests, resources, information, data, signals, or similar.

Optionally, the target domain 800 may comprise a memory 803. In some embodiments, the memory 803 of the target domain 800 can be configured to store program code that can be executed by the processing circuitry 801 of the target domain 800 to perform the method described herein in relation to the target domain 800. Alternatively or in addition, the memory 803 of the target domain 800, can be configured to store any requests, resources, information, data, signals, or similar that are described herein. The processing circuitry 801 of the target domain 800 may be configured to control the memory 803 of the target domain 800 to store any requests, resources, information, data, signals, or similar that are described herein. Embodiments described herein provide an automated mechanism for utilizing domain knowledge for determining whether a transfer of an ML model from a source domain to a target domain is feasible given feature definitions and measurement capabilities in respective domain. In particular, a one or more selected source domains may be determined that could provide a suitable transfer of an ML model.

Embodiments described herein are agnostic to data availability in the source and target domains, meaning that may be particularly useful with constrained devices. Furthermore, embodiments described herein may reduce energy consumption in the target domain by reusing knowledge obtained in a similar environment, and hence reducing ML training time. Again, this reduction in energy consumption may be particularly beneficial for constrained devices with limited energy resources.

For statistical based methods, the understanding of the statistical properties of the target domain primarily relies on (and is limited to) the given amounts of representative data in the target domain. In the extreme cases of very limited representative data in the target domain (e.g., a few samples), source selection in transfer learning based on statistical models may misleadingly be biased towards certain sources whom the target shares most similarity with. This can result in unpredictably poor performance. As such extreme scenarios may be typical in scenarios utilizing constrained devices such as IoT devices, using domain knowledge for source selection in transfer learning may be a more reliable approach.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A computer-implemented method for determining whether a machine learning model in a candidate source domain is suitable for use in a target domain, wherein the machine learning model is trained with one or more features, the method comprising:
determining, for each feature, one or more target measurement configurations indicating how data for the feature can be generated in the target domain;
for each feature, performing, for each of a plurality of candidate source domains, the steps of: determining one or more source measurement configurations indicating how data for the feature can be generated in the candidate source domain, and determining a similarity metric indicative of a similarity between the one or more source measurement configurations and the one or more target measurement configurations; and
based on the similarity metrics determined for each feature for the plurality of candidate source domains, selecting one or more selected source domains from the plurality of candidate source domains.

2. The computer-implemented method of claim h further comprising transmitting an indication of the one or more selected source domains to the target domain.

3. The computer-implemented method of claim 1, further comprising, for each feature:
obtaining an ontology for the feature, wherein the ontology describes possible measurement configurations that can be used to generate data for the feature in the plurality of candidate source domains and the target domain.

4. The computer-implemented method of claim 3, wherein the one or more source measurement configurations and the one or more target measurement configurations form paths through the ontology.

5. The computer-implemented method of claim 4, wherein, for each feature, the step of determining the similarity metric comprises comparing the paths through the ontology taken by the one or more source measurement configurations and the one or more target measurement configurations.

6. The computer-implemented method of claim 5, wherein, for each feature, the similarity metric comprises a sum of hops in the paths through the ontology taken by the one or more source measurement configurations and the one or more target measurement configurations that overlap.

7. The computer-implemented method of claim 6, wherein the sum is a weighted sum wherein each hop is associated with a weighting.

8. The computer-implemented method of claim 1, further comprising calculating an overall similarity based on the similarity metrics for each of the one or more features.

9. The computer-implemented method of claim 1, further comprising calculating the overall similarity by summing the similarity metrics for each of the one or more features, wherein
the overall similarity is a weighted sum of the similarity metrics for the each of the one or more features.

10. (canceled)

11. The computer-implemented method of claim 8, further comprising, determining that the candidate source domain is suitable for use in the target domain based on a value of the overall similarity being above a predetermined threshold.

12. The computer-implemented method of claim 9, further comprising
ranking the candidate source domains based on the value of the overall similarities, wherein candidate source domains with a higher overall similarities are ranked higher; and
selecting the one or more selected source domains as the highest ranked candidate source domains.

13. (canceled)

14. The computer-implemented method of claim 1, wherein the target measurement configurations and source measurement configurations comprise one or more of:
a measurement protocol, a sensor type, a measurement frequency, a measurement application, a sampling interval, and a network layer.

15. (canceled)

16. (canceled)

17. A method, in a target domain, for receiving a model trained with one or more features, the method comprising:
obtaining a one or more selected source domains;
selecting a first source domain from the one or more selected source domains;
transmitting a request to a model store for a model definition associated with the first source domain;
receiving the model definition; and
utilizing the model based on the model definition in the target domain.

18. The method of claim 17, further comprising updating weights in the model based on data collected in the target domain.

19. The method of claim 17, further comprising updating an ontology store with changes to one or more target measurement configurations indicating how data for the one or more features can be generated in the target domain.

20. A computer program product comprising a non-transitory computer readable medium, storing computer readable code being configured such that, on execution by a suitable computer or processor, the computer or processor is caused to perform the method of claim 1.

21. An apparatus for determining whether a machine learning model in a candidate source domain is suitable for use in a target domain, wherein the machine learning model is trained with one or more features, the apparatus comprising processing circuitry configured to cause the apparatus to:
determine, for each feature, one or more target measurement configurations indicating how data for the feature can be generated in the target domain;
for each feature, perform, for each of a plurality of candidate source domains, the steps of: determining one or more source measurement configurations indicating how data for the feature can be generated in the candidate source domain, and determining a similarity metric indicative of a similarity between the one or more source measurement configurations and the one or more target measurement configurations; and
based on the similarity metrics determined for each feature for the plurality of candidate source domains, select one or more selected source domains from the plurality of candidate source domains.

22. The apparatus of claim 21 wherein the processing circuitry is further configured to cause the apparatus to transmit an indication of the one or more selected source domains to the target domain.

23. (canceled)

24. (canceled)

25. A target domain, for receiving a model trained with one or more features, the target domain comprises processing circuitry configured to:
obtain a one or more selected source domains;
select a first source domain from the one or more selected source domains;
transmit a request to a model store for a model definition associated with the first source domain;
receive the model definition; and
utilize the model based on the model definition in the target domain.

26. The target domain of claim 25, wherein the target domain is further configured to update weights in the model based on data collected in the target domain.
